(19) United States
(12) Patent Application Publication
(10) Pub. No.: US 2025/0105544 A1
(43) Pub. Date: Mar. 27, 2025

(54) POWER AND OPTICAL CONNECTOR SYSTEM

(71) Applicant: Cisco Technology, Inc., San Jose, CA (US)

(72) Inventors: Joel Richard Goergen, Soulsbyville, CA (US); Chad M. Jones, Doylestown, OH (US); Jason Dewayne Potterf, Austin, TX (US); Mala Krishnan, Oakland, CA (US)

(21) Appl. No.: 18/416,338

(22) Filed: Jan. 18, 2024

Related U.S. Application Data
(60) Provisional application No. 63/585,252, filed on Sep. 26, 2023.

(51) Int. Cl. H01R 13/506

(52) U.S. Cl. CPC H01R 13/506

(57) ABSTRACT

The present embodiments are directed to a system with a first power assembly having a first power enclosure configured to attach to an optical plug and a first power connector disposed in the first power enclosure, as well as a second power assembly having a second power enclosure configured to attach to an optical enclosure that is configured to receive the optical plug and a second power connector disposed in the second power enclosure. The first power connector and the second power connector are configured to couple to each other.

### CROSS-REFERENCE TO RELATED APPLICATION

This application claims priority to and the benefit of U.S. Provisional Application No. 63/585,252, filed Sep. 26, 2023, which is hereby incorporated by reference in its entirety for all purposes.

### TECHNICAL FIELD

The present disclosure relates to a connector system with power and network signal delivery capabilities.

### BACKGROUND

An optical or network connector, such as an optical fiber connector, is used to communicate network signals (e.g., optical signals). For example, the optical connector is coupled to an optical or network module for routing network signals to the optical module and/or from the optical module. It may also be desirable to route power in addition to the network signals, such as to incorporate fault managed power (FMP) features for controlling operations based on power. However, it may be difficult to implement power routing capabilities to supplement network signal routing. For example, it may be costly and/or complex to implement an integrated component that routes network signals and power (e.g., through an optical module).

### BRIEF DESCRIPTION OF THE DRAWINGS

FIG. 1 is a schematic diagram of a connector system configured to deliver power and network signals, according to an example embodiment.

FIG. 2 is a front perspective view of a power assembly configured to couple to an optical plug, according to an example embodiment.

FIG. 3 is a front perspective view of another power assembly configured to couple to an optical enclosure, according to an example embodiment.

FIG. 4 is a front perspective view of a connector system configured to deliver power and network signals, according to an example embodiment.

FIG. 5 is a front perspective view of yet another power assembly configured to couple to an optical enclosure, according to an example embodiment.

FIG. 6 is a front perspective view of still another power assembly configured to couple to an optical enclosure, according to an example embodiment.

### DESCRIPTION OF EXAMPLE EMBODIMENTS

### Overview

Presented herein is a system comprising: a first power assembly comprising: a first power enclosure configured to attach to an optical plug; and a first power connector disposed in the first power enclosure; and a second power assembly comprising: a second power enclosure configured to attach to an optical enclosure, the optical enclosure being configured to receive the optical plug; and a second power connector disposed in the second power enclosure, wherein the first power connector and the second power connector are configured to couple to each other.

### Example Embodiments

Embodiments presented herein are directed to a connector system configured to route power and network signals. For example, the connector system includes an optical plug coupled to an optical enclosure. The optical plug may include optical connectors that are coupled to an optical module of the optical enclosure. Thus, network signals may be transmitted between the optical plug and the optical enclosure via the optical connectors and the optical module. As an example, the optical enclosure may be mounted to a printed circuit board (PCB), and the network signals may be transmitted to and/or transmitted from the PCB to operate the PCB. Additionally, the connector system includes a first power assembly and a second power assembly. The first power assembly includes first power connectors, and the second power assembly includes second power connectors. The first power connectors and the second power connectors are configured to couple to each other. As such, power may be transmitted between the first power connectors and the second power connectors. By way of example, the first power assembly and the second power assembly may route power with respect to the PCB to operate the PCB based on the power.

The first power assembly may be configured to removably couple to the optical plug, and the second power assembly may be configured to removably couple to the optical enclosure. That is, the first power assembly may be able to attach to the optical plug and be readily detached from the optical plug. Similarly, the second power assembly may be able to attach to the optical enclosure and be readily detached from the optical enclosure. For instance, the first power assembly may include first extensions that are configured to engage with the optical plug, such as via an interference fit, to attach to the optical plug, and the second power assembly may include second extensions that are configured to engage with the optical enclosure, such as via another interference fit, to attach to the optical enclosure. The removable coupling feature of the first power assembly and of the second power assembly may enable implementation and/or removal of power routing capabilities without affecting coupling of the optical plug and the optical enclosure to each other to route network signals. In other words, attachment/detachment of the first power assembly with respect to the optical plug and attachment/detachment of the second power assembly with respect to the optical module may be separate from coupling of the optical plug and the optical enclosure to each other. By way of example, the first extensions may be removed from engagement with the optical plug and the second extensions may be removed from engagement with the optical enclosure, thereby detaching the first power assembly from the optical plug and detaching the second power assembly from the optical enclosure, without having to decouple the optical plug from the optical enclosure. Thus, network signals may continue to be transmitted while power routing features are adjusted (e.g., by attaching or detaching the power assemblies to implement or remove, respectively, power routing capabilities). As such, the power assemblies may enable implementation of power routing more appropriately, more selectively, and/or more easily (e.g., without having to modify the optical plug and/or the optical enclosure.

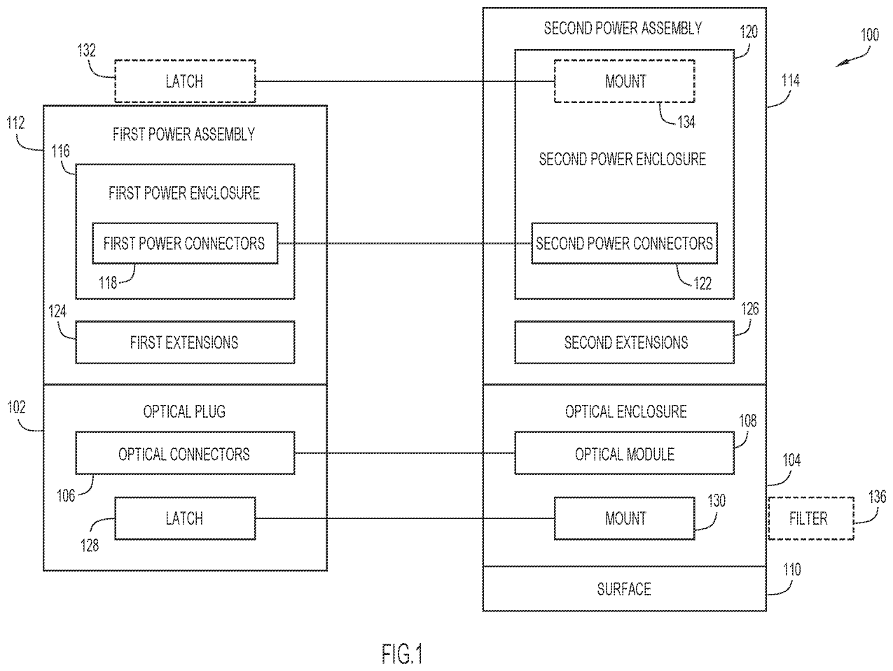

With the preceding in mind, FIG. 1 is a schematic diagram of a connector system 100 (e.g., a copper connector system). The connector system 100 may include an optical plug 102 and an optical enclosure 104 (e.g., an optical housing, an optical cage) configured to couple to each other to route network signals (e.g., power over Ethernet, data stream, optical signals) therebetween. For example, the optical plug 102 may include optical connectors 106 (e.g., optical conductors) configured to couple to an optical module 108 of the optical enclosure 104, and the optical connectors 106 may be configured to direct network signals to the optical module 108 and/or direct network signals from the optical module 108. In some embodiments, the optical enclosure 104 is mounted onto a surface 110, such as of an electronic component (e.g., a PCB). Thus, the connection of the optical plug 102 and the optical enclosure 104 with each other may enable routing of network signals to and/or from the electronic component, such as for enabling the electronic component to communicate with another electronic component.

The connector system 100 may also include a first power assembly 112 and a second power assembly 114 configured to couple to each other to route power therebetween. The first power assembly 112 may include a first power enclosure 116 (e.g., a first power housing) with first power connectors 118 (e.g., first power conductors, copper connectors), and the second power assembly 114 may include a second power assembly 120 (e.g., a second power housing) with second power connectors 122 (e.g., second power conductors, copper connectors). The first power connectors 118 and the second power connectors 122 may couple to each other to route power from the first power assembly 112 to the second power assembly 114 and/or from the second power assembly 114 to the first power assembly 112. By way of example, the first power assembly 112 and the second power assembly 114 may be implemented to route power to and/or from the electronic component to which the optical enclosure 104 is coupled. For instance, power routing features may enable operation of the electronic component based on power, such as for FMP (e.g., initiating, suspending, adjusting operation based on power). The power connectors 118, 122 may include a single phase (e.g., a pair of positive power and negative power) or multiple phases (e.g., multiple pairs of positive power and negative power).

In some embodiments, the first power assembly 112 may be configured to couple to the optical plug 102 and/or the second power assembly 114 may be configured to couple to the optical enclosure 104. To this end, the first power assembly 112 may include first extensions 124 configured to engage with the optical plug 102 to attach the first power assembly 112 to the optical plug 102 and the second power assembly 114 may include second extensions 126 configured to engage with the optical enclosure 104 to attach the second power assembly 114 to the optical enclosure 104. Additionally, the first extensions 124 may enable the first power assembly 112 to be readily detached from the optical plug 102 (e.g., via a manually applied force) and the second extensions 126 may enable the second power assembly 114 to be readily detached from the optical enclosure 104 (e.g., via a manually applied force). Thus, the first extensions 124 and the second extensions 126 may facilitate case of implementation of the first power assembly 112 and/or of the second power assembly 114 to enable power routing capabilities.

For instance, the removable coupling capability of the first power assembly 112 with respect to the optical plug 102 and of the second power assembly 114 with respect to the optical enclosure 104 may enable implementation and/or removal of the power assemblies 112, 114 without having to modify arrangement of the optical plug 102 and/or of the optical enclosure 104. Thus, the arrangement of the optical plug 102 and the optical enclosure 104 may be better maintained to enable more selective implementation and/or removal of power transmission capabilities, such as in comparison with an embodiment in which power and network signal transmission components are integral with each other and/or an embodiment in which separate power and network transmission components are coupled to each other by connecting to a common component.

As an example, the first power assembly 112 may be attached to the optical plug 102 and detached from the optical plug 102 via the first extensions 124 and/or the second power assembly 114 may be attached to the optical enclosure 104 and detached from the optical enclosure 104 via the second extensions 126 separate from and without affecting the coupling of the optical plug 102 and the optical enclosure 104 to each other (e.g., by decoupling the optical connectors 106 and the optical module 108 from each other). In this manner, network signals may continue to be transmitted between the optical plug 102 and the optical enclosure 104 while the first power assembly 112 and/or the second power assembly 114 are being adjusted (e.g., to implement power routing capabilities, to remove power routing capabilities). As another example, the first power assembly 112 may be attached to the optical plug 102 without having to modify a structure of the optical plug 102 and/or the second power assembly 114 may be attached to the optical enclosure 104 without having to modify a structure of the optical enclosure 104. Therefore, a limited quantity of operations may be performed to implement the power assemblies 112, 114. Indeed, the removable coupling features discussed herein may improve an case of implementation for existing systems that include an optical plug and an optical enclosure. For example, an existing system that already includes an optical plug and an optical enclosure coupled to each other may be readily retrofitted with the first power assembly 112 and/or with the second power assembly 114 to enable power routing features (e.g., without having to modify the arrangement of the optical plug and/or of the optical enclosure).

In some embodiments, the optical plug 102 may include a latch 128 and the optical enclosure 104 may include a mount 130 for securing the optical plug 102 and the optical enclosure 104 to each other. That is, engagement of the latch 128 to the mount 130 may prevent or at least discourage unintentional decoupling of the optical plug 102 from the optical enclosure 104. In additional or alternative embodiments, the first power assembly 112 may include or be coupled to a latch 132, the second power assembly 120 of the second power assembly 114 may include a mount 134, and the latch 132 and the mount 134 are configured to engage each other for securing the power assemblies 112, 114 to each other (e.g., to prevent or at least discourage unintentional decoupling of the power assemblies 112, 114 from each other). For instance, in certain embodiments, the latch 128 is movable and can be positioned at the optical plug 102 for engagement with the mount 130 of the optical enclosure 104 or at the first power assembly 112 for engagement with the mount 134 of the second power assembly 114. As such, the latch 128 may be selectively arranged for securing the optical plug 102 and the optical enclosure 104 to each other and/or for securing the power assemblies 112, 114 to each other. In further embodiments, the optical enclosure 104 may include the latch 128 and the optical plug 102 may include the mount 130, and/or the second power assembly 114 may include the latch 132 and the first power assembly 112 may include the mount 134.

Moreover, in certain embodiments, the connector system 100 may include a filter 136 (e.g., an electromagnetic compatibility filter, a ferrite) to maintain integrity of network signals. That is, the filter is configured to block interference of power transmission provided by the power assemblies 112, 114 with respect to network signals transmitted between the optical plug 102 and the optical enclosure 104. Although the filter 136 is coupled to the optical enclosure 104 in the illustrated embodiment, the filter 136 may be implemented in any other suitable manner, such as attached to the first power assembly 112, attached to the optical plug 102, attached to the second power assembly 114 (e.g., between the optical enclosure 104 and a portion of the second power assembly 114), and/or attached to the surface 110, in additional or alternative embodiments.

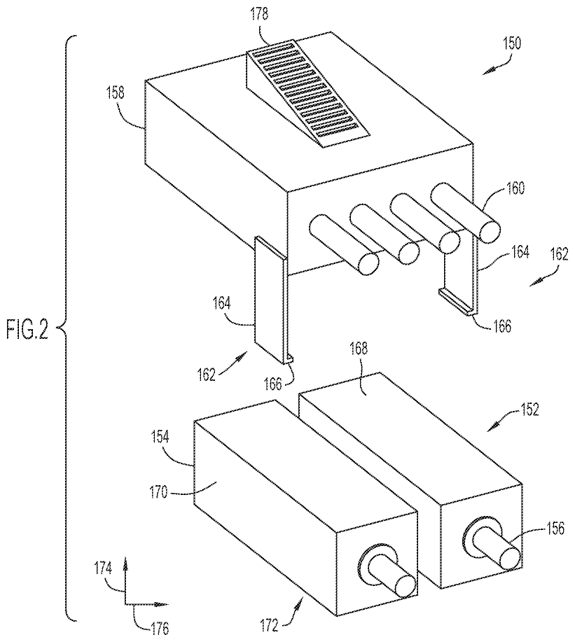

FIG. 2 is a front perspective view of a first power assembly 150 (e.g., the first power assembly 112) and an optical plug 152 (e.g., the optical plug 102) configured to couple to each other. The optical plug 152 may include a main body 154 and optical connectors 156 extending from the main body 154. For example, a portion of the optical connectors 156 may be routed through the main body 154, while another portion of the optical connectors 156 may be exposed and therefore accessible for coupling to another component, such as an optical module. The optical connectors 156 may be configured to route network signals.

The first power assembly 150 may include a first power enclosure 158 (e.g., a first power housing) and first power connectors 160 (e.g., first power conductors) extending from the first power enclosure 158. For instance, a portion of the first power connectors 160 may be routed through and shielded by the first power enclosure 158, while another portion of the first power connectors 160 may be exposed and therefore accessible for coupling to another component, such as corresponding power connectors of another power assembly. The first power connectors 160 may be configured to route power. Since the first power connectors 160 are separate from the optical plug 152, the first power assembly 150 may route power separately and independently from the network signals routed by the optical connectors 156 of the optical plug 152.

Additionally, the first power assembly 150 may include first extensions 162 (e.g., hooks) extending from the first power enclosure 158. The first extensions 162 may be configured to engage with (e.g., snap onto, clamp onto) the main body 154 to couple the first power assembly 150 to the optical plug 152. By way of example, each first extension 162 may include a first segment 164 extending from the first power enclosure 158 and a second segment 166 extending crosswise (e.g., perpendicularly) from the first segment 164. Such a shape of the first extensions 162 may enable the first power enclosure 158, the first power enclosure 158, and the first extensions 162 to conform to a shape of the main body 154 to cooperatively capture the main body 154 and secure the first power assembly 150 to the optical plug 152 via an interference fit. For instance, the first power enclosure 158 may be configured to contact a first end wall 168 of the main body 154, the first segments 164 may be configured to contact respective sidewalls 170 of the main body 154, and the second segment 166 may be configured to contact a second end wall 172, opposite the first end wall 168, of the main body 154. Thus, the first extensions 162 may provide an interference fit for coupling to the main body 154. For example, the engagement of the first power enclosure 158 with the first end wall 168 and the engagement of the second segments 166 with the second end wall 172 may block movement of the first power assembly 150 relative to the optical plug 152 along a first axis 174 (e.g., a vertical axis), and engagement of the first segments 164 with the respective sidewalls 170 may block movement of the first power assembly 150 relative to the optical plug 152 along a second axis 176 (e.g., a horizontal axis). Thus, engagement of the first extensions 162 with the main body 154 may substantially block relative movement between the first power assembly 150 and the optical plug 152.

Additionally, the first extensions 162 may be readily detached from the main body 154 to decouple the first power assembly 150 from the optical plug 152. As an example, the first segments 164 may be bent such that the second segments 166 are moved away from each other and away from the second end wall 172 to disengage the second segments 166 from the second end wall 172. As a result, a sufficiently sized gap may be provided between the second segments 166 to enable movement of the optical plug 152 through the gap along the first axis 174 to separate the optical plug 152 from the first power assembly 150. In this manner, the first extensions 162 may be used to couple the first power assembly 150 to and decouple the first power assembly 150 from the optical plug 152 without having to modify an arrangement of the optical plug 152. In some embodiments, an additional feature, such as a fastener, a solder connection, and/or an adhesive, may be used to further secure the first power assembly 150 and the optical plug 152 to each other. In additional or alternative embodiments, a feature (e.g., an existing feature, an additional feature provided through modification) of the optical plug 152 may be utilized to secure the first power assembly 150 to the optical plug 152. For instance, the first extensions 162 may be inserted into an opening or hole formed through a portion of the optical plug 152 to secure the first power assembly 150 to the optical plug 152 via the first extensions 162.

The illustrated first power assembly 150 includes a latch 178 positioned on the first power enclosure 158. The latch 178 may be configured to couple to another component, such as a mount of another power assembly to couple the first power assembly 150 to the other power assembly. In certain embodiments, the latch 178 may be removably coupled to the first power enclosure 158 and can be detached from the first power enclosure 158 and, for instance, couplable to the main body 154 (e.g., at the first end wall 168, at the second end wall 172) of the optical plug 152 to enable the optical plug 152 to secure to another component via the latch 178. In either case, the latch 178 provides additional securement capabilities.

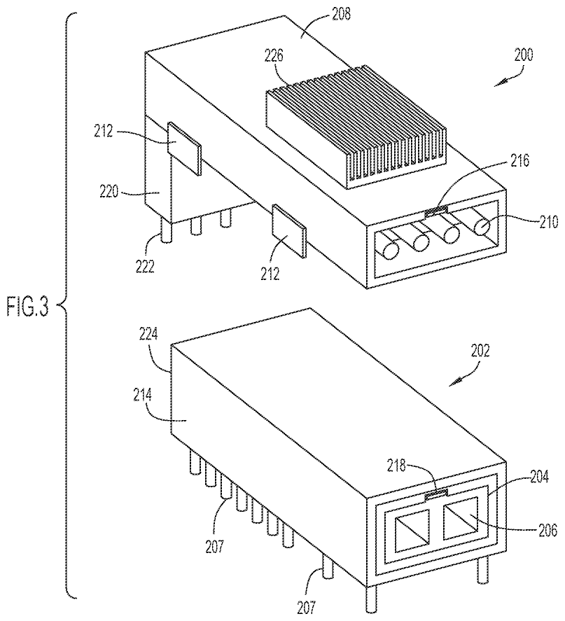

FIG. 3 is a front perspective view of a second power assembly 200 (e.g., the second power assembly 114) and an optical enclosure 202 (e.g., the optical enclosure 104, an optical housing) configured to couple to each other. The optical enclosure 202 may include an optical module 204 configured to couple to the optical connectors 156, thereby enabling routing of network signals between the optical plug 152 and the optical enclosure 202. As an example, the optical module 204 may include sockets or openings 206 in which the main body 154 of the optical plug 152 may be inserted to extend the optical connectors 156 within the optical module 204 (e.g., for coupling to corresponding components of the optical enclosure 202 within the optical module 204). In some embodiments, the optical enclosure 202 may be configured to mount to a surface (e.g., of a PCB). To this end, the optical enclosure 202 may include pins 207 (e.g., ground pins, signal pins) for mounting to the surface, such as using solder connections. The second power assembly 200 may include a second power enclosure 208 and second power connectors 210 extending through and shielded by the second power enclosure 208. For instance, the second power connectors 210 are configured to receive the first power connectors 160 of the first power assembly 150 to enable routing of power between the first power assembly 150 and the second power assembly 200. Although four first power connectors 160 are illustrated in FIG. 2 and four second power connectors 210 are illustrated in FIG. 3, it should be noted that the first power assembly 150 may include any suitable quantity of first power connectors 160 and the second power assembly 200 may correspondingly include any suitable quantity of second power connectors 210. For instance, two, six, eight, ten, twelve, or more first power connectors 160 and second power connectors 210 may be utilized.

The second power assembly 200 may include second extensions 212 (e.g., tabs) extending from the second power enclosure 208. The second extensions 212 may be configured to engage with (e.g., snap onto, clamp onto) the optical enclosure 202 to couple the second power assembly 200 to the optical enclosure 202. For example, the second extensions 212 may be configured to contact sidewalls 214 of the optical enclosure 202, thereby providing an interference fit for coupling to the optical enclosure 202. Moreover, the second extensions 212 may be readily detached from the optical enclosure 202 to decouple the second power assembly 200 from the optical enclosure 202. For instance, the second extensions 212 may be bent to disengage from the sidewalls 214 and enable movement of the second power assembly 200 relative to the optical enclosure 202 to decouple the second power assembly 200 from the optical enclosure 202 without having to modify an arrangement of the optical enclosure 202. In certain embodiments, an additional feature, such as a fastener, a solder, and/or an adhesive, may be used to secure the second power assembly 200 and the optical enclosure 202 to each other. In additional or alternative embodiments, a feature, such as a hole, of the optical enclosure 202 may be utilized to secure the second power assembly 200 to the optical enclosure 202 via the second extensions 212 (e.g., by inserting the second extensions 212 into a hole formed through the optical enclosure 202).

The illustrated second power assembly 200 includes a mount 216 configured to match with the latch 178 to secure the second power assembly 200 to the first power assembly 150. For example, the mount 216 may include an opening configured to receive the latch 178. Additionally or alternatively, the optical enclosure 202 may include a mount 218 configured to match with the latch 178 (e.g., a movable latch configured to be positioned on the main body 154) or another latch to secure the optical enclosure 202 to the optical plug 152.

Furthermore, the second power assembly 200 may be configured to route power around the optical enclosure 202 and onto the surface to which the optical enclosure 202 is coupled. To this end, the second power enclosure 208 may include an extended portion 220 configured to mount to the surface, such as via pins 222 (e.g., using a solder connection and/or an interference fit). The extended portion 220 may be configured to extend along or in contact with a wall 224 (e.g., a rear wall) of the optical enclosure 202, opposite of where the optical plug 152 is configured to couple to the optical module 204. The second power connectors 210 may extend through and be shielded by the extended portion 220 to contact the pins 222 and enable power flow around (e.g., external to) the optical enclosure 202, along the wall 224, and through the pins 222 (e.g., to/from the surface to which the pins 222 are coupled). As such, the second power connectors 210 may be separate from the optical enclosure 202, and the second power assembly 200 may route power separately and independently from the network signals routed by the optical module 204 of the optical enclosure 202.

The second power assembly 200 may include a heatsink 226 mounted to the second power enclosure 208 and configured to absorb heat and discharge heat away from the second power assembly 200. In one example, heat may be generated at the optical enclosure 202 (e.g., as a result of transmission of network signals, as a result of heat conduction from the surface to which the optical enclosure 202 is coupled), the heat may transfer from the optical enclosure 202 to the second power enclosure 208 of the second power assembly 200 (e.g., via conduction), and the heat may transfer from the second power enclosure 208 to the heatsink 226 (e.g., via conduction) for dissipation. In another example, heat may be generated at the second power assembly 200 (e.g., as a result of transmission of power), and the heat may transfer from the second power enclosure 208 to the heatsink 226. In either case, the heatsink 226 may limit a temperature increase of the second power assembly 200 and/or of the optical enclosure 202, which may help maintain a structural integrity of the second power assembly 200 and/or of the optical enclosure 202 to maintain desirable operation and/or increase a useful lifespan of the second power assembly 200 and/or of the optical enclosure 202.

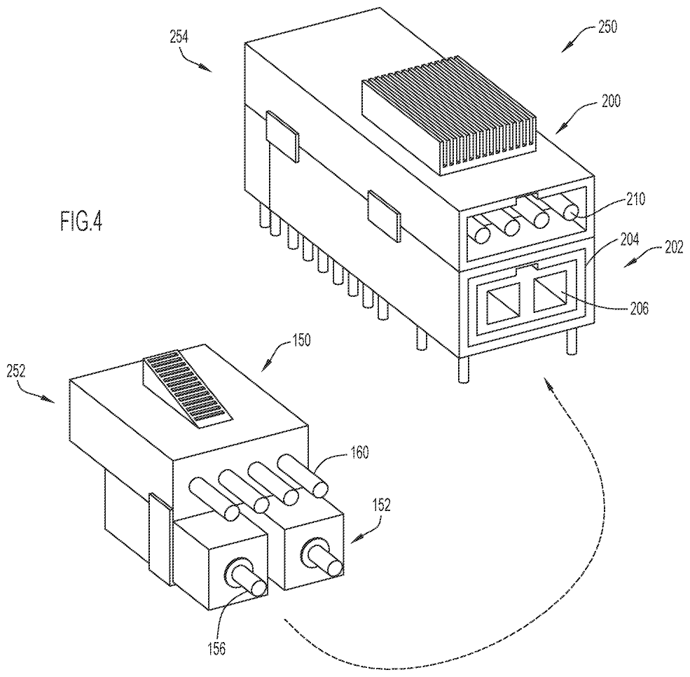

FIG. 4 is a front perspective view of a connector system 250 having the first power assembly 150 and the optical plug 152 coupled to each other to provide a first assemblage 252, as well as the second power assembly 200 and the optical enclosure 202 coupled to each other to provide a second assemblage 254. The first assemblage 252 and the second assemblage 254 may be coupled to each other. For example, coupling of the first assemblage 252 and the second assemblage 254 to each other may couple the first power connectors 160 of the first power assembly 150 to the second power connectors 210 of the second power assembly 200 (e.g., by inserting the first power connectors 160 into the second power connectors 210) and couple the optical connectors 156 of the optical plug 152 to the optical module 204 of the optical enclosure 202 (e.g., by inserting the optical connectors 156 into the openings 206). Thus, the first power assembly 150 and the optical plug 152 may initially be coupled to each other to provide the first assemblage 252 and the second power assembly 200 and the optical enclosure 202 may initially be coupled to each other to provide the second assemblage 254, and then the first assemblage 252 and the second assemblage 254 may be coupled to each other to couple the first power assembly 150 and the second power assembly 200 to each other and to couple the optical plug 152 and the optical enclosure 202 to each other. The connector system 250 may also be disassembled by separating the first assemblage 252 and the second assemblage 254 from each other. In other words, the first power assembly 150 and the second power assembly 200 may be decoupled from each other and the optical plug 152 and the optical enclosure 202 may be decoupled from each other while the first power assembly 150 and the optical plug 152 remain coupled to each other and the second power assembly 200 and the optical enclosure 202 remain coupled to each other.

However, the connector system 250 may be assembled and/or disassembled using another technique. For example, the optical plug 152 and the optical enclosure 202 may initially be coupled to each other and, separately, the first power assembly 150 and the second power assembly 200 may initially be coupled to each other, and the coupled power assemblies 150, 200 may then be attached to the coupled optical plug 152 and optical enclosure 202. In such an embodiment, transmission of network signals may initially be enabled via the optical plug 152 and the optical enclosure 202 that are coupled to each other before transmission of power is enabled by implementing the power assemblies 150, 200. By way of example, transmission of network signals may initially be desired and provided by implementing the optical plug 152 and the optical enclosure 202. After the transmission of network signals has been implemented, a determination may be made that transmission of power is also desirable. In response, the power assemblies 150, 200 may be implemented without having to change the transmission of network signals effectuated by the optical plug 152 and the optical enclosure 202. As such, transmission of power may be more selectively and appropriately implemented via the power assemblies 150, 200, such as independently from transmission of network signals via the optical plug 152 and the optical enclosure 202. For disassembly, the first power enclosure 158 may be detached from the optical plug 152 and the second power enclosure 208 may be detached from the optical enclosure 202 without decoupling the optical plug 152 and the optical enclosure 202 from each other and/or without decoupling the first power assembly 150 and the second power assembly 200 from each other. Thus, networks signals may continue to be transmitted while the first power assembly 150 and the second power assembly 200 are removed.

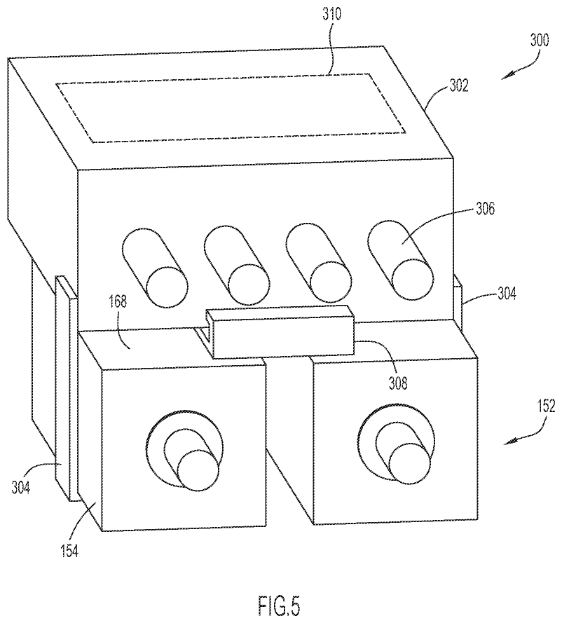

FIG. 5 is a front perspective view of a third power assembly 300 (e.g., the first power assembly 112) and the optical plug 152 coupled to each other. For example, the third power assembly 300 may include a third power enclosure 302 and third extensions 304 (e.g., hooks) extending from the third power enclosure 302. The third extensions 304 may be configured to engage with (e.g., capture, clamp onto, snap onto) the main body 154 of the optical plug 152. Third power connectors 306 (e.g., third power conductors) may extend from the third power enclosure 302 and may be coupled to another component, such as corresponding power connectors of another power assembly.

In addition, a latch 308 is coupled to the optical plug 152. For instance, the latch 308 is attached to the first end wall 168 of the main body 154, such as positioned between the first end wall 168 and the third power connectors 306. In such an embodiment, the latch 308 may be configured to couple to the mount 218 of the optical enclosure 202 to secure the optical plug 152 to the optical enclosure 202. However, the latch 308 may be movable in certain embodiments. By way of example, the third power enclosure 302 of the third power assembly 300 may include mounting features 310 (e.g., holes, grooves), and the latch 308 may be removed from the first end wall 168 and coupled to the third power enclosure 302 via the mounting features 310, such as for coupling to the mount 216 of the second power assembly 200 to secure the third power assembly 300 and the second power assembly 200 to each other. Thus, the latch 308 may be selectively positioned.

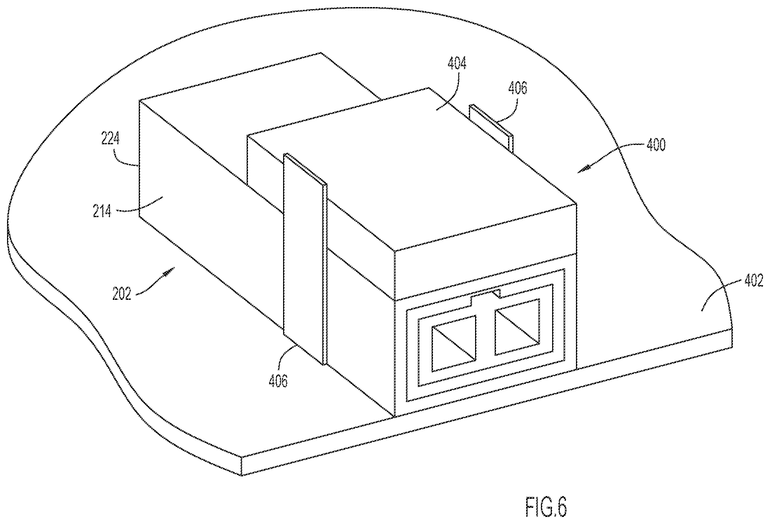

FIG. 6 is a front perspective view of a fourth power assembly 400 (e.g., the second power assembly 114) and the optical enclosure 202 coupled to each other. The illustrated optical enclosure 202 is coupled to a surface 402, such as of a PCB. The fourth power assembly 400 may include a fourth power enclosure 404 (e.g., a fourth power housing) having extended portions 406. The extended portions 406 may extend along or in contact with the respective sidewalls 214 of the optical enclosure 202 to route power along the respective sidewalls 214 and around (e.g., external to) the optical enclosure 202. The extended portions 406 may be configured to mount to the surface 402, such as via pins (not shown) to route power to the surface 402. Thus, the optical module 204 may route power without having to extend to the wall 224 of the optical enclosure 202.

Although the illustrated embodiments show a single power assembly (e.g., the first power assembly 150, the third power assembly 300) configured to couple to the optical plug 152 and a single power assembly (e.g., the second power assembly 200, the fourth power assembly 400) configured to couple to the optical enclosure 202, in additional or alternative embodiments, multiple power assemblies may concurrently couple to the optical plug 152 and/or multiple power assemblies may concurrently couple to the optical enclosure 202. By way of example, power assemblies may couple to opposite sides (e.g., a top side, a bottom side) of the optical plug 152 and/or of the optical enclosure 202, such as to route positive power and negative power at opposite sides of a PCB in a double stack module configuration. In further embodiments, a power assembly may be configured to couple to the optical plug 152 and/or to the optical enclosure 202 in a different manner, such as to one of the sidewalls 170 of the optical plug 152 and/or one of the sidewalls 214 of the optical enclosure 202.

In some aspects, the techniques described herein relate to a system including: a first power assembly including: a first power enclosure configured to attach to an optical plug; and a first power connector disposed in the first power enclosure; and a second power assembly including: a second power enclosure configured to attach to an optical enclosure, the optical enclosure being configured to receive the optical plug; and a second power connector disposed in the second power enclosure, wherein the first power connector and the second power connector are configured to couple to each other.

In some aspects, the techniques described herein relate to a system, wherein the first power assembly includes extensions extending from the first power enclosure, and the extensions are configured to engage the optical plug to attach the first power enclosure to the optical plug.

In some aspects, the techniques described herein relate to a system, wherein the second power assembly includes extensions extending from the second power enclosure, and the extensions are configured to engage the optical enclosure to attach the second power enclosure to the optical enclosure.

In some aspects, the techniques described herein relate to a system, further including a latch coupled to the first power assembly, wherein the second power assembly includes a mount formed on the second power enclosure and configured to match with the latch to couple the first power assembly and the second power assembly to each other.

In some aspects, the techniques described herein relate to a system, wherein the second power connector is configured to receive the first power connector to couple the first power connector and the second power connector to each other.

In some aspects, the techniques described herein relate to a system, wherein the second power assembly includes a heatsink mounted to the second power enclosure, and the heatsink is configured to discharge heat away from the second power assembly.

In some aspects, the techniques described herein relate to a system, wherein the first power enclosure is configured to detach from the optical plug and the second power enclosure is configured to detach from the optical enclosure without decoupling the first power connector and the second power connector from each other.

In some aspects, the techniques described herein relate to a system including: an optical enclosure including an optical module; an optical plug including an optical connector configured to insert into the optical module; a first power assembly including a first power enclosure configured to attach to the optical plug; and a second power assembly including a second power enclosure configured to attach to the optical enclosure, wherein the first power assembly and the second power assembly are configured to couple to each other.

In some aspects, the techniques described herein relate to a system, wherein the second power assembly includes power connectors configured to route power around the optical enclosure.

In some aspects, the techniques described herein relate to a system, wherein the second power enclosure includes an extended portion configured to extend along a sidewall of the optical enclosure, and the power connectors extend through the extended portion to route power along the sidewall and around the optical enclosure.

In some aspects, the techniques described herein relate to a system, wherein the second power enclosure includes an extended portion configured to extend along a wall of the optical enclosure, opposite of where the optical connector of the optical plug is configured to insert into the optical module, and the power connectors extend through the extended portion to route power along the wall and around the optical enclosure.

In some aspects, the techniques described herein relate to a system, including a latch attached to the optical plug, wherein the optical enclosure includes a mount configured to couple to the latch to secure the optical plug and the optical enclosure to each other.

In some aspects, the techniques described herein relate to a system, wherein the first power assembly includes power connectors extending from the first power enclosure, and attachment of the first power enclosure to the optical plug positions the latch between the power connectors and the optical plug.

In some aspects, the techniques described herein relate to a system, wherein the optical enclosure is configured to mount to a surface, and the second power enclosure includes an extended portion configured to extend along the optical enclosure and mount to the surface.

In some aspects, the techniques described herein relate to a system including: a first power assembly including a first power connector; and a second power assembly including a second power connector configured to couple to the first power connector, wherein the first power assembly is configured to attach to and detach from an optical plug and the second power assembly is configured to attach to and detach from an optical enclosure separate from coupling of the optical plug and the optical enclosure to each other.

In some aspects, the techniques described herein relate to a system, wherein the first power assembly includes a power enclosure and hooks extending from the power enclosure, wherein the power enclosure and the hooks are configured to cooperatively capture the optical plug to attach the first power assembly to the optical plug.

In some aspects, the techniques described herein relate to a system, wherein the first power assembly includes a first power enclosure, the second power assembly includes a second power enclosure, the second power enclosure includes a mount, and the system includes a latch positioned on the first power enclosure and configured to couple to the mount of the second power enclosure to secure the first power assembly and the second power assembly to each other.

In some aspects, the techniques described herein relate to a system, wherein the first power enclosure includes a mounting feature, the latch is configured to removably couple to the mounting feature to be positioned on the first power enclosure.

In some aspects, the techniques described herein relate to a system, wherein the second power assembly includes a power enclosure, the power enclosure includes an extended portion configured to extend around the optical enclosure, and the second power connector extends through the extended portion to route power around the optical enclosure.

In some aspects, the techniques described herein relate to a system, including the optical plug and the optical enclosure, wherein the optical plug includes a main body and an optical connector extending from the main body, the optical enclosure includes an optical module with an opening, and the opening is configured to receive the main body and the optical connector to couple the optical plug and the optical enclosure to each other.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

Further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure are described with more particular reference to the accompanying figures above.

Similarly, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially.”

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system comprising:
a first power assembly comprising:
a first power enclosure configured to attach to an optical plug; and
a first power connector disposed in the first power enclosure; and
a second power assembly comprising:
a second power enclosure configured to attach to an optical enclosure, the optical enclosure being configured to receive the optical plug; and
a second power connector disposed in the second power enclosure, wherein the first power connector and the second power connector are configured to couple to each other.

2. The system of claim 1, wherein the first power assembly comprises extensions extending from the first power enclosure, and the extensions are configured to engage the optical plug to attach the first power enclosure to the optical plug.

3. The system of claim 1, wherein the second power assembly comprises extensions extending from the second power enclosure, and the extensions are configured to engage the optical enclosure to attach the second power enclosure to the optical enclosure.

4. The system of claim 1, further comprising a latch coupled to the first power assembly, wherein the second power assembly comprises a mount formed on the second power enclosure and configured to match with the latch to couple the first power assembly and the second power assembly to each other.

5. The system of claim 1, wherein the second power connector is configured to receive the first power connector to couple the first power connector and the second power connector to each other.

6. The system of claim 1, wherein the second power assembly comprises a heatsink mounted to the second power enclosure, and the heatsink is configured to discharge heat away from the second power assembly.

7. The system of claim 1, wherein the first power enclosure is configured to detach from the optical plug and the second power enclosure is configured to detach from the optical enclosure without decoupling the first power connector and the second power connector from each other.

8. A system comprising:
an optical enclosure comprising an optical module;
an optical plug comprising an optical connector configured to insert into the optical module;
a first power assembly comprising a first power enclosure configured to attach to the optical plug; and
a second power assembly comprising a second power enclosure configured to attach to the optical enclosure, wherein the first power assembly and the second power assembly are configured to couple to each other.

9. The system of claim 8, wherein the second power assembly comprises power connectors configured to route power around the optical enclosure.

10. The system of claim 9, wherein the second power enclosure comprises an extended portion configured to extend along a sidewall of the optical enclosure, and the power connectors extend through the extended portion to route power along the sidewall and around the optical enclosure.

11. The system of claim 9, wherein the second power enclosure comprises an extended portion configured to extend along a wall of the optical enclosure, opposite of where the optical connector of the optical plug is configured to insert into the optical module, and the power connectors extend through the extended portion to route power along the wall and around the optical enclosure.

12. The system of claim 8, comprising a latch attached to the optical plug, wherein the optical enclosure comprises a mount configured to couple to the latch to secure the optical plug and the optical enclosure to each other.

13. The system of claim 12, wherein the first power assembly comprises power connectors extending from the first power enclosure, and attachment of the first power enclosure to the optical plug positions the latch between the power connectors and the optical plug.

14. The system of claim 8, wherein the optical enclosure is configured to mount to a surface, and the second power enclosure comprises an extended portion configured to extend along the optical enclosure and mount to the surface.

15. A system comprising:
a first power assembly comprising a first power connector; and
a second power assembly comprising a second power connector configured to couple to the first power connector,
wherein the first power assembly is configured to attach to and detach from an optical plug and the second power assembly is configured to attach to and detach from an optical enclosure separate from coupling of the optical plug and the optical enclosure to each other.

16. The system of claim 15, wherein the first power assembly comprises a power enclosure and hooks extending from the power enclosure, wherein the power enclosure and the hooks are configured to cooperatively capture the optical plug to attach the first power assembly to the optical plug.

17. The system of claim 15, wherein the first power assembly comprises a first power enclosure, the second power assembly comprises a second power enclosure, the second power enclosure comprises a mount, and the system comprises a latch positioned on the first power enclosure and configured to couple to the mount of the second power enclosure to secure the first power assembly and the second power assembly to each other.

18. The system of claim 17, wherein the first power enclosure comprises a mounting feature, the latch is configured to removably couple to the mounting feature to be positioned on the first power enclosure.

19. The system of claim 15, wherein the second power assembly comprises a power enclosure, the power enclosure comprises an extended portion configured to extend around the optical enclosure, and the second power connector extends through the extended portion to route power around the optical enclosure.

20. The system of claim 15, comprising the optical plug and the optical enclosure, wherein the optical plug comprises a main body and an optical connector extending from the main body, the optical enclosure comprises an optical module with an opening, and the opening is configured to receive the main body and the optical connector to couple the optical plug and the optical enclosure to each other.
